(19) United States
(12) Patent Application Publication
(10) Pub. No.: US 2023/0385384 A1
(43) Pub. Date: Nov. 30, 2023

(54) HYBRID MACHINE LEARNING ARCHITECTURE AND ASSOCIATED METHODS

(71) Applicant: THALES NEDERLAND B.V., Hengelo (NL)

(72) Inventors: Gregor PAVLIN, HENGELO OV (NL); Lennard JANSEN, HENGELO OV (NL); Franck MIGNET, HENGELO OV (NL)

(21) Appl. No.: 17/829,142

(22) Filed: May 31, 2022

(51) Int. Cl. G06K 9/62; G06N 7/00

(52) U.S. Cl. CPC G06K 9/6277; G06K 9/6296; G06N 7/005

(57) ABSTRACT

A method of building a computer implemented data classifier for classifying data from a certain context is provided, whereby the classifier is based on a model obtained by transfer learning combining Probabilistic Graphical Models (PGM) and arbitrary, context independent machine learned models enabled by special modelling patterns, where variables representing outputs of machine learned models are added to the PGM.

### FIELD OF THE INVENTION

The present invention relates to Machine Learning.

### BACKGROUND

Machine learning is used as a means for classifying data in many fields. One very common example is in the classification of images. Images are generally characterised by carrying rich patterns, which contain a significant portion of features that do not necessarily dependent on the context, such as for example the place of acquisition, time and various environmental conditions.

Other types of data are sparse, and their patterns may have a particular meaning only in the specific context from which the data originate. For example, we may consider data obtained from tracking systems using radars, cameras and the like, which typically comprise sequences of locations, speeds and orientations.

FIGS. 1a, 1b, 1c and 1d present scenarios illustrating this point in relation to naval tracking data.

FIG. 1a presents a first set of tracking data in a first context corresponding to a specific area.

As shown in FIG. 1a, a first linear trajectory, represented by a solid line is aligned approximately North-South, and a second linear trajectory, represented by a dashed line is aligned approximately East West. It may be noted with respect to the underlying geography that the first trajectory moves up and down a channel between two headlands, whilst the second trajectory moves back and forth from one headland to the other. On this basis, it might be concluded that the first trajectory reflects the movements of cargo ships moving through the channel, while the second trajectory corresponds to a passenger ferry moving back and forth between land masses.

FIG. 1b presents a second set of tracking data in the second context corresponding to a specific area.

As shown in FIG. 1b, a third linear trajectory, represented by a solid line is aligned approximately North-South, and a fourth linear trajectory, represented by a dashed line is aligned approximately East West. It may be noted with respect to the underlying geography that the fourth trajectory moves up and down a channel between two headlands, whilst the third trajectory moves back and forth from one headland to the other. On this basis, it might be concluded that the Fourth trajectory reflects the movements of cargo ships moving through the channel, while the third trajectory corresponds to a passenger ferry moving back and forth between land masses.

Accordingly, in FIGS. 1a and 1b, substantially equivalent data have exactly opposite interpretations, due to the underlying context.

FIG. 1c presents a third set of tracking data in the first context.

As shown in FIG. 1c, a fifth linear trajectory represented by a solid line, and a sixth trajectory comprising a series of dashed loops are provided. It may be noted with respect to the underlying geography that the fifth trajectory moves up and down a channel between two headlands, whilst the sixth trajectory moves in circular patterns between the two headlands, in the vicinity of dock infrastructure. On this basis, it might be concluded that the fifth trajectory reflects the movements of fishing boat moving from dock to the fishing banks, while the sixth trajectory corresponds to cargo ships manoeuvring in port.

FIG. 1d presents a fourth set of tracking data in a second context.

As shown in FIG. 1d, a seventh linear trajectory represented by a solid line, and an eighth trajectory comprising a series of dashed loops are provided. It may be noted with respect to the underlying geography that the seventh trajectory moves up and down a shipping lane in open water, whilst the eighth trajectory moves back and forth from the deep sea to the shore. On this basis, it might be concluded that the seventh trajectory reflects the movements of a cargo ship proceeding along its international route, while the eighth trajectory corresponds to fishing boat pursuing shoals of fish.

As such, once again, in FIGS. 1c and 1d, substantially equivalent data have exactly opposite interpretations, due to the underlying context.

This dependence on Context and sparse data of the kind presented above means that certain common machine learning approaches, such as for example Neural Networks might not be best suited.

Probabilistic Graphical Models meanwhile may be seen as better suited to such fields due to their ability to efficiently model the context and causal relations. They facilitate inclusion of expert knowledge and can automatically learn the specific properties of a context, however the size and complexity of Probabilistic Graphical Models grows with the number of relations and the states of variables, making the learning of such models challenging to efficiently capture intricate behaviours requiring higher modelling resolution, such as U-turns, ZIG-ZAGs and the like in the context presented above.

Attempts to combine different types of models through machine learning are known for example from the article by Y. Bengio, R. De Mori, G. Flammia, and R. Kompe entitled “Global optimization of a neural network-hidden Markov model hybrid.” Published in IEEE Transactions on Neural Networks, 3(2): 252-259, 1992 and Diederik P Kingma, Danilo J Rezende, Shakir Mohamed and Max Welling: Semi-Supervised Learning with Deep Generative Models, NIPS, 2014.

It is accordingly desired to develop new Machine learning structures better addressing the foregoing considerations.

### SUMMARY OF THE INVENTION

In accordance with the present invention in a first aspect there is provided a method of building a computer implemented data classifier for classifying data from a specified context (C1), the method comprising the steps of:
obtaining a Probabilistic Graphical Model comprising a set of variables comprising a first set of Observable variables (Var1, Var2, Var3, . . . , VarN), and a class variable , whereby the probabilistic model comprises parameters defining dependencies between the variables of the set of variables, obtaining a machine learning model that is trained on second training data (D2) comprising a second set of Observable variables (VarA, VarB . . . VarZ), extending the Probabilistic Graphical Model to comprise one or more Extension variables (VarX1, VarX2 . . . , VarXN), each Extension variable corresponding to the outputs of the machine learning model, and performing an embedding training of the extended Probabilistic Graphical Model on the basis of an embedding training set of data, the embedding training set comprising first training data (D1.1) of data from the specified context (C1) and an inferred machine learning model output (O1.2) inferred by the machine learning model from third training data (D1.2) from context C1 corresponding to the second set of Observable variables (VarA, VarB . . . VarZ), whereby third training data (D1.2) is sampled from the context (C1) together with the first training data (D1.1), to obtain an enhanced Probabilistic Graphical Model comprising parameters defining dependencies between the Observable variables, the class variable and each Extension variable.

In a development of the first aspect, one or more Observable variables (Var1, Var2, Var3, . . . , VarN) of a Probabilistic Graphical Model are directly dependent on the class Variable, and one or more Latent variables.

In a development of the first aspect, the Probabilistic Graphical Model is extended with one or more Extension variables (VarX1, VarX2 . . . , VarXN), whereby the Extension variables are directly dependent on the class variable, one or more Latent variables and possibly one or more Observable variables.

In a development of the first aspect, the step of obtaining a Probabilistic Graphical Model comprises training the Probabilistic Graphical Model with the first training data (D1.1) from the specified context (C1), the first training data comprising data corresponding to a first set of one or more Observable variables (Var1, Var2, Var3, . . . , VarN), whereby embedding training using the embedding training set modifies only the parameters corresponding to the dependencies between the Extension variables and other variables in the extended Probabilistic Graphical Model.

In a development of the first aspect, embedding training using the embedding training set modifies all parameters corresponding to the dependencies between all variables in the extended Probabilistic Graphical Model.

In a development of the first aspect, there are provided one or more further machine learning models each said further machine learning model comprising said second set of Observable variables (VarA, VarB, . . . , VarZ), and each said further machine learning model output O1.2 comprising probabilities corresponding to the values of said Extension variables (VarX1, VarX2, . . . , VarXN) of said extended Probabilistic Graphical Model, and wherein
said step of performing an embedding training of said extended Probabilistic Graphical Model is performed, such that conditional probability tables of said Extension variables (VarX1, VarX2 . . . , VarXN) are obtained.

In a development of the first aspect, there are provided one or more further machine learning models each said further machine learning model comprising said second set of Observable variables (VarA, VarB, . . . , VarZ), and each said further machine learning model output O1.2 comprising values that are not probabilities, the values corresponding to the states of Observed Extension Variables, a subset of the Extension variables (VarX1, VarX2 . . . , VarXN), whereas the rest of the Extension variables are Latent Extension Variables, wherein the Observed Extension Variables are conditioned on the Latent Extension Variables, and the step of performing an embedding training of a Probabilistic Graphical Model is performed such that for each Observed Extension Variable and each Latent Extension Variable a specific probability table is obtained.

In a development of the first aspect, the Extension variables are directly dependent on the class variable

In a development of the first aspect, the second training data (D2) belongs to the specified context (C1).

In a development of the first aspect, the step of training the machine learning model comprises incorporating the machine learning model as the Latent representation of an autoencoder.

In a development of the first aspect, the machine learning model is trained in an unsupervised mode.

In a development of the first aspect, the context comprises the conditions corresponding to the geographic locations, time and the type of moving entities in a physical space under which the data is sampled.

In a development of the first aspect, the first training data, second training data and third training data comprise kinematic data for moving entities in a physical space.

In a development of the first aspect, the first training data, second training data and third training data further comprise images, video streams, sound or electromagnetic signatures.

In accordance with the present invention in a second aspect there is provided method of classifying data comprising presenting the data to a classifier in accordance with the first aspect.

In accordance with development of the method of the first or second aspects, the method is applied to classification of targets in combat management systems, or in processing of sensor observations or detections of moving targets, wherein the first set of Observable variables (Var1, Var2, Var3, . . . , VarN) and the second set of Observable variables (VarA, VarB, VarC, . . . , VarZ) correspond to (i) the outputs of various sensors perceiving the targets and (ii) outputs of sources describing the environmental conditions and wherein the dependencies between the Observable variables, the class variable and each Extension variable describe the correlations between the context, the observations and the target class, enabling classification of a target, prediction of its states or detection of anomalous target states.

In accordance with the present invention in a third aspect the method of the first or second aspect is applied to detection of anomalies in IT systems, cyber physical systems and detection of cyber attacks, wherein the first set of Observable variables (Var1, Var2, Var3, . . . , VarN) and the second set of Observable variables (VarA, VarB, VarC, . . . , VarZ) correspond to the readings from various IDS probes at different system levels and wherein the dependencies between the Observable variables, the class variable and each Extension variable describe the correlations between different components of the overall system, such that the states of unobservable components can be predicted or anomalous states of components can be detected.

In accordance with the present invention in a fourth aspect there is provided a data processing system comprising means for carrying out the steps of the method of any of the first, second, or third aspects.

In accordance with the present invention in a fifth aspect there is provided a computer program comprising instructions which, when the program is executed by a computer, cause the computer to carry out the method of any of the first, second, third or fourth aspects.

In accordance with the present invention in a seventh aspect there is provided a computer-readable medium comprising instructions which, when executed by a computer, cause the computer to carry out the method of any of the first, second, third or fourth aspects.

### BRIEF DESCRIPTION OF THE DRAWINGS

The invention will be better understood and its various features and advantages will emerge from the following description of a number of exemplary embodiments provided for illustration purposes only and its appended Figures in which:

FIG. 1a presents a first set of tracking data in a first context corresponding to a specific area;

FIG. 1b presents a second set of tracking data in the second context corresponding to a specific area;

FIG. 1c presents a third set of tracking data in the first context;

FIG. 1d presents a fourth set of tracking data in a second context;

FIG. 2a represents a first step in a method in accordance with an embodiment;

FIG. 2b represents a second step in a method in accordance with an embodiment;

FIGS. 2c-i represents a first variant of a third step in a method in accordance with an embodiment;

FIGS. 2c-ii represent a second variant of a third step in a method in accordance with an embodiment.

FIG. 2d-i represents a first variant of a fourth step in a method in accordance with an embodiment;

FIG. 2d-ii represents a second variant of a fourth step in a method in accordance with an embodiment; and

FIG. 3 summarises the method as presented with reference to FIGS. 2a, 2b, 2c-i, 2c-ii, 2d-i and 2d-ii.

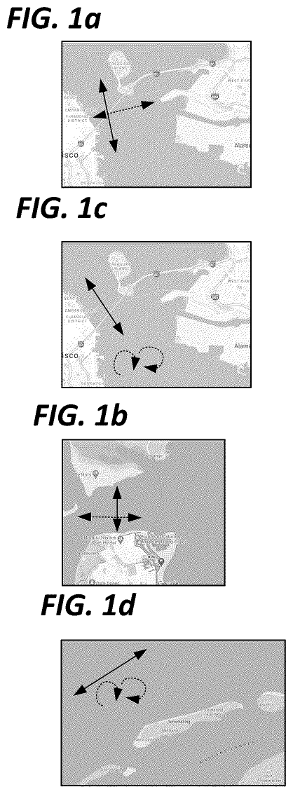

### DETAILED DESCRIPTION

In general terms, it is desired to implement a transfer learning mechanism, whereby detailed behaviours learned by a Neural Network or the like may be reused in a different context, whose characteristics are captured in a Probabilistic Graphical Model. Transfer learning mechanisms are conventionally used in pure Deep Neural Networks, where parts of one Neural Network are transferred to a different Neural Network. Incorporating Neural Network elements into a Probabilistic Graphical Model to achieve a hybrid model requires different approaches.

In contrast to prior art methods, embodiment of the present invention make use of arbitrarily complex PGM and introduces special patterns with Latent variables enabling efficient embedding of machine learned components and automated learning of the context. Moreover, embodiments support simultaneous or gradual integration of multiple, very different types of machine learning components, which can be also carried out in a fully unsupervised fashion.

In Bayesian Networks, an important class of Probabilistic Graphical Models used for the illustration, Graphs encode the types of dependencies between the variables (qualitative domain knowledge), while Conditional probability tables encode the strength of dependencies. Graphs are often transferable, being the same for all contexts, while the Conditional probability tables are NOT transferable and must be relearned for each context.

A neural network meanwhile may support efficient training of Fine grained/high resolution models, such as those of behaviours (U-turns, ZIG-ZAG, . . . ). The training can be based on supervised OR unsupervised learning. This learning may be valid under different conditions and consequently can be reused in different contexts, however unsupervised learning results in models capturing “Tacit” knowledge—that is not necessarily comprehensible a posteriori.

In accordance with embodiments, the objective of merging neural network learning with a Probabilistic Graphical Model may be achieved by using a special modelling pattern/harness in the Probabilistic Graphical Model supporting automated learning of relations between embedded features, the classes and the context.

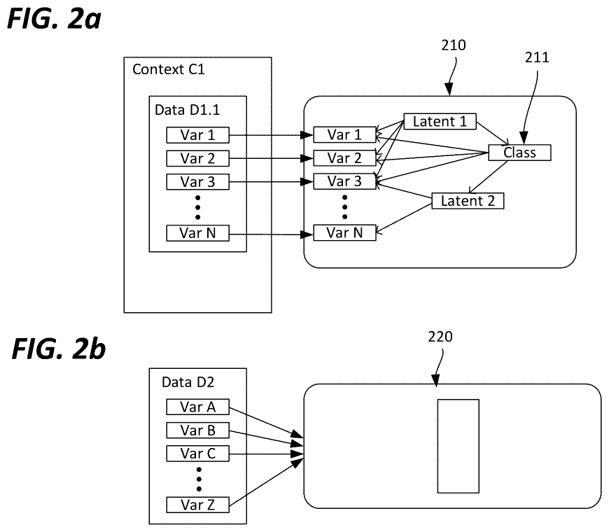

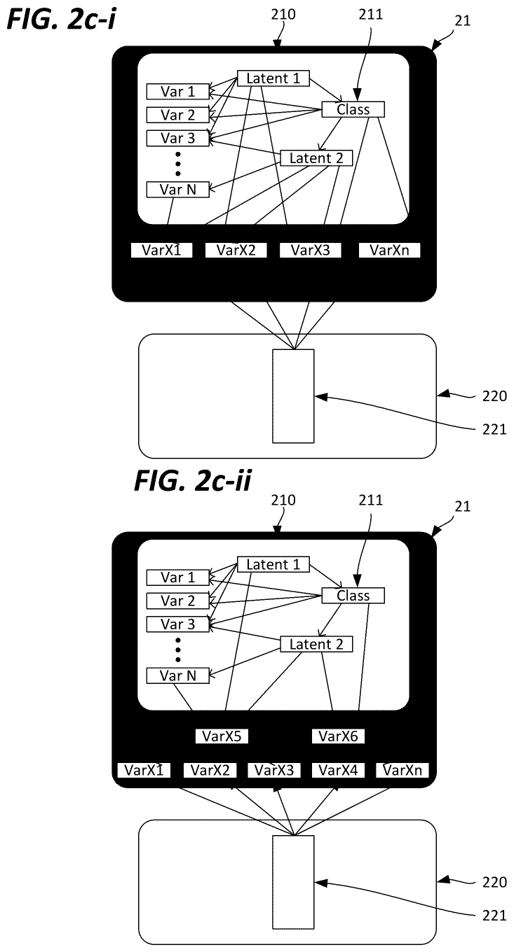

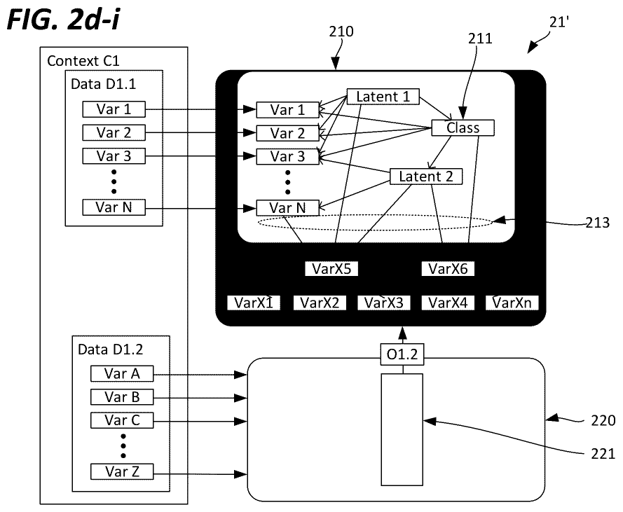

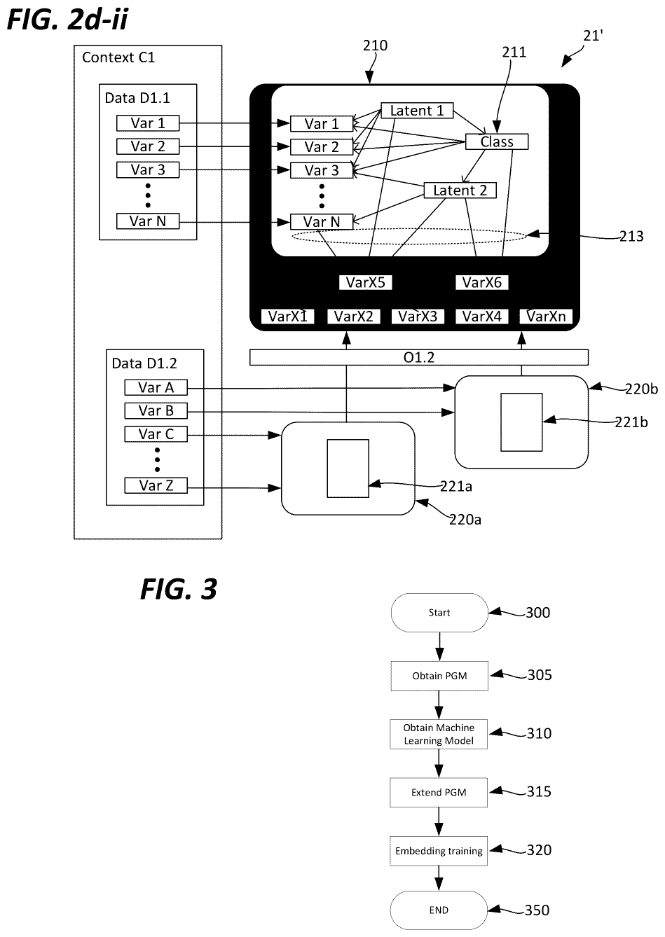

FIGS. 2a, 2b, 2c-i, 2c-ii, 2d-i and 2d-ii represent steps in a method in accordance with an embodiment.

FIG. 2a represents a first step in a method in accordance with an embodiment.

In particular, FIG. 2a, steps in a method of building a computer implemented data classifier for classifying data from a specified context (C1).

The context may comprise the conditions corresponding to the geographic locations, time and the type of moving entities in a physical space under which the data is sampled.

In accordance with a first step as illustrated in FIG. 2a, a Probabilistic Graphical Model 210 is obtained. This Probabilistic Graphical Model is represented by way of example as a Directed Graph, a Bayesian Network reflecting the structure/form of the Conditional Probability Tables, although the skilled person will appreciate that other equivalent representations are known, based on Joint probability distribution tables, etc. The Model comprises a set of variables comprising a first set of Observable variables (Var1, Var2, Var3, . . . , VarN), and a class variable 211, whereby the probabilistic model 210 comprises parameters defining direct dependencies between the variables of the set of variables, as known to the skilled person in the field of Probabilistic Graphical Models. The Probabilistic Graphical Model 210 is illustrated as comprising N tables for N Observable variables (denoted by Var1 through VarN) and a table representing prior distribution over the class variable, as well as two tables for the Latent variables by way of example, however the skilled person will appreciate that the Probabilistic Graphical Model 210 may have any structure as known in the art. In particular, the Probabilistic Graphical Model may comprise one or more of Observable variables, zero or more Latent variables, and one or more of class variables, and any number within these ranges as appropriate to the data and context.

A Special modelling pattern enables automated context learning by means of a graph structure in the Probabilistic Graphical Model, where observed variables directly depend on the class variable and one or more Latent variables and the Latent variables may in some cases directly influence the class variable or vice versa. The Latent variables represent context. In FIG. 2a this pattern was used to define dependencies between Var1, Var2, Var3, Latent 1, Latent 2 and class variables.

It will be appreciated that while in some embodiments obtaining the Probabilistic Graphical Model 210 may involve actually training a Probabilistic Graphical Model from the data D1.1, the Probabilistic Graphical Model may comprise a predefined “off the shelf” Probabilistic Graphical Model for a particular context, or may be defined manually by directly defining the variables and manually setting the respective probability tables.

Where the Probabilistic Graphical Model is trained for the purposes of an embodiment, this training may comprise the application of an Expectation-maximization algorithm, a gradient descent optimization method, or other training technique as known in the art.

Probabilistic Graphical Model may be of any type as may occur to the skilled person. In particular, the Probabilistic Graphical Model may comprise a Bayesian network, whereby the parameters comprise prior probabilities and conditional probabilities for each variable.

FIG. 2b represents a second step in a method in accordance with an embodiment.

In accordance with a second step as illustrated in FIG. 2b, a machine learning model 220 is obtained that is trained on second training data (D2) comprising a second set of Observable variables (VarA, VarB, . . . , VarZ).

The machine learning model may comprise any Machine learning model as will be apparent to the skilled person, such as a Decision Tree structure, Hidden Markov Model, Support Vector Machine, or a further Probabilistic Graphical Model, or a neural network.

Optionally, the machine learning model may be trained in an unsupervised mode. For example, the training of the machine learning model may comprise an Autoencoder or a Variational Autoencoder comprising a set of Latent variables corresponding to the machine learning model outputs.

It will be appreciated that while in some embodiments obtaining the machine learning model 220 may involve actually training a machine learning model from the data D2, the machine learning model 220 may comprise a predefined “off the shelf” machine learning model for a particular context, or may be defined manually by directly defining the variables and manually setting the respective probability weightings with regard to the other variables.

In some variants, the second training data (D2) may belong to the first context C1. In other variants, the second training data (D2) may belong to a further context (C2) different from the specified context (C1).

FIG. 2c-i represents a first variant of a third step in a method in accordance with an embodiment.

In accordance with a third step as illustrated in FIG. 2c-i, the Probabilistic Graphical Model 210 is extended to obtain an extended Probabilistic Graphical Model 21. In a case where machine learning models output probability distributions, the Probabilistic Graphical Model 210 may be extended to comprise one or more Observable Extension Variables (VarX1, VarX2, VarX3, . . . , VarXN), each Extension variable corresponding to the outputs of the machine learning models that output probability distributions.

Where the machine learning model does not output probabilities, for example in case the output corresponds to the “Latent space representation” as produced by an autoencoder, the Extension Variables are arranged differently.

FIG. 2c-ii represents a second variant of a third step in a method in accordance with an embodiment.

Like numbered features correspond generally to those presented with respect to the previous Figures.

In FIG. 2c-ii, the Probabilistic Graphical Model 210 is extended to comprise one or more Extension Variables (VarX1, VarX2, VarX3, . . . , VarXN), some of which are Observable Extension variables corresponding to the outputs of the machine learning model that are not probabilities, and the rest are Latent Extension Variables that implement clustering functions interfacing the Observable Extension Variables with the rest of the model 210. Specifically, as shown in FIG. 2C-ii by way of example, VarX1, VarX2, VarX3, VarX4 and VarXN are Observable Extension Variables, whereas VarX5 and VarX6 are Latent Extension Variables.

The skilled person will appreciate that a given implementation may comprise any or all of these interface types in any combination.

Moreover, the Probabilistic Graphical Model may be extended with one or more Extension variables (VarX1, VarX2, VarX3 . . . , VarXN), whereby the Extension variables are directly dependent on the class variable, one or more Latent variables and possibly one or more Observable variables. Specifically, as shown in FIG. 2C-i by way of example, VarX3 is dependent on Latent Variable 1, Latent Variable 2, and the class variable. In FIG. 2C-ii this pattern is applied to VarX6, whereby it depends on Latent Variable 2 and the class Variable. This pattern supports efficient learning of the context influencing the relations between the outputs of the machine learned models and the class variable. The Latent variables in these cases can absorb the knowledge about the confounding influences of the context.

Naturally any other configuration may be envisaged as dictated by the structure of the elements used and the characteristics of the underlying data.

In the variant as shown in FIG. 2c-i, some Extension variables are directly dependent on the class variable. In the variant of FIG. 2C-ii meanwhile, Latent Extension variables varX5 and VarX6 are defined, where the observed Extension variables may be dependent on the Latent Extension variables only. Accordingly, as shown in FIG. 2c-ii, observed Extension variables varX1 and VarX2 are shown schematically as dependent on Latent Extension variable VarX5, and observed Extension variables varX3 , VarX4 and VarXN are shown schematically as dependent on Latent Extension variable VarX6, while Latent Extension variable VarX5 depends on VarN, Latent variable 1 and Latent variable 2, and Latent Extension variable VarX6 depends on Latent variable 2 and the class variable. Naturally any other configuration may be envisaged as dictated by the structure of the elements used and the characteristics of the underlying data. Still further, all observed Extension variables may be dependent on the class variables and additionally, in some or all cases, on one or more other Latent Extension variables.

Accordingly, Extension variables may be directly dependent on the class variable. In some embodiments, this may be the case for all Extension variables, or all observed Extension variables. Where embodiments define Latent Extension variables, the observed Extension variable may be dependent on the Latent Extension variables only. Still further, all observed Extension variables may be dependent on the class variables and additionally, in some or all cases, on one or more other Latent Extension variables.

The skilled person will appreciate that structures may combine the approaches of FIG. 2c-i and FIG. 2c-ii, by providing certain Observable Extension variables depending directly on both Observable and Latent variables of model 210, in parallel with Latent Extension variables, upon which further Extension variables may depend either exclusively, or together with direct dependency.

FIG. 2d-i represents a fourth step in a method in accordance with an embodiment.

In accordance with a fourth step as illustrated in FIG. 2d-i, an embedding training of the extended Probabilistic Graphical Model is performed on the basis of an embedding training set of data, the embedding training set comprising first training data (D1.1) of data from the specified context (C1) and an inferred machine learning model output (O1.2) inferred by the machine learning model from third training data (D1.2) from context C1 corresponding to the second set of Observable variables (VarA, VarB, . . . , VarZ), whereby the third training data D1.2 is sampled from the context C1 together with the first training data D1.1, to obtain an enhanced Probabilistic Graphical Model 21′ comprising parameters 213 defining dependencies between the Observable variables, Latent variables, the class variable and each Extension variable.

The step of training or embedding training the Probabilistic Graphical Model may comprise the application of an Expectation-maximization algorithm.

The step of training or embedding training the Probabilistic Graphical Model may comprise the application of gradient decent optimization method.

The parameters may comprise priors and conditional probabilities for each variable.

Where the context comprises the conditions corresponding to the geographic locations, time and the type of moving entities in a physical space under which the data is sampled, and the first training data, second training data and third training data may comprise kinematic data for moving entities in a physical space.

The first training data, second training data and third training data further comprise images, video streams, sound or electromagnetic signatures.

The step of obtaining an extended Probabilistic Graphical Model may comprise applying an embedding training to a predefined Probabilistic Graphical Model with training data sampled from the specified context (C1) comprising data corresponding to one or more Observable variables (Var1, Var2, Var3, . . . , VarN), in which case the embedding training using the embedding training set may modify only the parameters corresponding to the dependencies between the Extension variables and other variables in the extended Probabilistic Graphical Model. A practical benefit of such an approach is that the embedding training can be carried out in a fully unsupervised way, without using any class labels corresponding to the data patterns in the first training data (D1.1).

Alternatively, the embedding training may modify all parameters corresponding to the dependencies between all variables in the extended Probabilistic Graphical Model. In such a case the data patterns in the first training data (D1.1) must be associated with the class labels.

While FIGS. 2a, 2b, 2c-i, 2c-ii and 2d-i present a method having recourse to a single Machine Learning Model 220, it will be appreciated that there may be provided one or more further machine learning models, where each further machine learning model comprises a subset of the second set of Observable variables.

FIG. 2d-ii represents a second variant of a fourth step in a method in accordance with an embodiment.

As shown in FIG. 2d-ii, there may be provided a first machine learning model 220a corresponding to machine learning model 220 as described above, and a further machine learning model 220b. Each further machine learning model 220a, 220b comprises a subset of the second set of Observable variables (VarA, VarB . . . , VarZ). In such situations, each machine learning model 220a, 220b, may provide a respective output which represents a subset of O1.2 comprising probabilities corresponding to the values of a subset of the Extension variables (VarVarX1, VarX2, . . . , VarXN) of the extended Probabilistic Graphical Model. Each machine learning model 220a, 220b can thus be trained on different, but complementary data. Accordingly, the step of performing an embedding training of the extended Probabilistic Graphical Model may then be performed on the basis of each respective output, a subset of O1.2, such that conditional probability tables of the Extension variables (VarVarX1, VarX2 . . . , VarXN) are obtained.

Similarly, each further machine learning model output O1.2 may comprise values that are not probabilities corresponding to the states of Observed Extension Variables, a subset of the Extension variables (VarVarX1, VarX2 . . . , VarXN), whereas the rest of the Extension variables are Latent Extension Variables, wherein the Observed Extension Variables are conditioned on the Latent Extension Variables. As such, the step of performing an embedding training of a Probabilistic Graphical Model is performed such that for each Observed Extension Variable and each Latent Extension Variable a specific probability table is obtained.

FIG. 3 summarises the method as presented with reference to FIGS. 2a, 2b, 2c-i, 2c-ii, 2d-i and 2d-ii.

As shown, the method begins at step 300 before proceeding to step 305 at which a Probabilistic Graphical Model comprising a set of variables comprising a first set of Observable variables (Var1, Var2, Var3, . . . , VarN), and a class variable is obtained, whereby the probabilistic model comprises parameters defining dependencies between the variables of the set of variables.

The method next proceeds to a step 310 of obtaining a machine learning model that is trained on second training data (D2) corresponding to a second set of Observable variables (VarA, VarB, . . . , VarZ).

The method next proceeds to a step 315 of extending the Probabilistic Graphical Model to comprise one or more Extension variables (VarVarX1, VarX2, . . . , VarXN), where some or all of the Extension variables correspond to the outputs of the machine learning model.

The method next proceeds to a step 320 of performing an embedding training of the extended Probabilistic Graphical Model on the basis of an embedding training set of data, the embedding training set comprising first training data (D1.1) of data from the specified context (C1) and an inferred machine learning model output (O1.2) inferred by the machine learning model from third training data (D1.2) from context C1 comprising the second set of Observable variables (VarA, VarB, . . . , VarZ), whereby third training data set D1.2 is sampled from the context C1 (or another context C2 as discussed herein) together with the first training data D1.1, to obtain an enhanced Probabilistic Graphical Model comprising parameters defining dependencies between the Observable variables, the class variable and each Extension variable.

It will be appreciated that this approach provided important benefits. The combination of Machine learning techniques such as Neural Network based techniques with Probabilistic Graphical Models may allow unsupervised learning for the fusion of the feature. During the learning process part of the data is injected into the Probabilistic Graphical Model directly while the other part is “compressed” through the feature embedding/classification component prior to injecting into the Probabilistic Graphical Model. This is because the Expectation—maximization algorithm can carry out general inference about any unobserved variable during learning.

New features may be added without re-learning the entire model, so that it becomes possible for example to easily add new features corresponding to new data sources, such as sensors, as they become available.

The resulting classifier can work with incomplete data (e.g. if a feature is disabled), without any data imputation, hence a robust solution offering graceful degradation is provided.

The described approach is suitable for a generic Probabilistic Graphical Model, imposes no pre-constraints on the type of the inputs, and allows for independent optimization of components. Moreover, different machine learned models can be added to the overall solution over time, as they become available, without the need to retrain the entire set of previously known models and a significant portion of the Probabilistic Graphical Model's parameters.

A classifier obtained as described herein may be used to classify data by presenting data thereto.

Embodiments have been described above in terms of Multi-Loop Bayesian Networks, which offer advantageous characteristics in certain contexts. The presented concepts can be extended to arbitrary classes of Probabilistic Graphical Models, such as any type of Bayesian Network, including for example Dynamic Bayesian Networks and Markov Networks.

Applications of embodiments have been mentioned in the context of the processing of geographical information. It will be appreciated that there exist countless other contexts in which the mechanisms described herein may be particularly useful. Another example may concern the detection of anomalies in IT systems, cyber physical systems or the detection of cyber attacks. In such a context, the first set of Observable variables (Var1, Var2, Var3, . . . , VarN) and the second set of Observable variables (VarA, VarB, VarC, . . . , VarZ) may correspond to the readings from various IDS (Intrusion Detection System) probes at different system levels. The dependencies between the Observable variables, class variable and each Extension variable may then describe the correlations between different components of the overall system, such that the states of unobservable components can be predicted or anomalous states of components can be detected.

This may comprise the further step of displaying information on anomalies and/or cyber attacks on a display, wherein preferably the detected anomalies and cyber attacks are labelled or it is otherwise indicated which type of anomalies or cyber attacks are detected.

A still further application may comprise classification of targets in combat management systems, or in processing of sensor observations or detections of moving targets. In such a context, the first set of Observable variables (Var1, Var2, Var3, . . . , VarN) and the second set of Observable variables (VarA, VarB, VarC, . . . , VarZ) may correspond to (i) the outputs of various sensors perceiving the targets and (ii) outputs of sources describing the environmental conditions. The dependencies between the Observable variables, the class variable and each Extension variable may then describe the correlations between the context, the observations and the target class, enabling classification of a target, prediction of its states or detection of anomalous target states. As such, embodiments may comprise a system such as a radar processing system, combat management system or sensor processing system, comprising a processor or other components adapted for to implement the mechanisms described herein. In particular, there may be provided a vehicle such as a ship, for example a war ship, comprising such a system.

This may comprise the further step of displaying the targets and/or the target states on a display, wherein preferably the targets are labelled or it is otherwise indicated which type of targets are displayed.

The disclosed methods can take form of an entirely hardware embodiment (e.g. FPGA), an entirely software embodiment or an embodiment containing both hardware and software elements. Software embodiments include but are not limited to firmware, resident software, microcode, etc. The invention can take the form of a computer program product accessible from a computer-usable or computer-readable medium providing program code for use by or in connection with a computer or an instruction execution system. A computer-usable or computer-readable can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium.

Accordingly, there is provided a data processing system comprising means for carrying out the steps of the method as described above, for example with reference to FIGS. 2a, 2b, 2c-i, 2c-ii, 2d-i, 2d-ii or 3.

The data processing system may comprise a display and/or display interface for displaying results of determinations made in accordance with embodiments for example as described above, for example displaying combat management systems targets and/or the target states, wherein preferably the targets are labelled or it is otherwise indicated which type of targets are displayed. Similarly, such a display and/or display interface may be adapted for displaying information on anomalies and/or cyber attacks, wherein preferably the detected anomalies and cyber attacks are labelled or it is otherwise indicated which type of anomalies or cyber attacks are detected.

Similarly, there is provided a computer program comprising instructions which, when the program is executed by a computer, cause the computer to carry out the steps of the method as described above, for example with reference to FIGS. 2a, 2b, 2c-i, 2c-ii, 2d-i, 2d-ii or 3.

Similarly, there is provided a computer-readable medium comprising instructions which, when executed by a computer, cause the computer to carry out the steps of the method as described above, for example with reference to FIGS. 2a, 2b, 2c-i, 2c-ii, 2d-i, 2d-ii or 3.

In particular, a method of building a computer implemented data classifier for classifying data from a certain context is provided, whereby the classifier is based on a model obtained by transfer learning combining Probabilistic Graphical Models (PGM) and arbitrary, context independent machine learned models enabled by special modelling patterns, where variables representing outputs of machine learned models are added to the PGM.

These methods and processes may be implemented by means of computer-application programs or services, an application-programming interface (API), a library, and/or other computer-program product, or any combination of such entities.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of building a computer implemented data classifier for classifying data from a specified context (C1), said method comprising the steps of:
obtaining a Probabilistic Graphical Model comprising a set of variables comprising a first set of Observable variables (Var1, Var2, Var3, . . . , VarN), and a class variable, whereby said probabilistic model comprises parameters defining dependencies between the variables of said set of variables,
obtaining a machine learning model that is trained on second training data (D2) comprising a second set of Observable variables (VarA, VarB . . . , VarZ),
extending said Probabilistic Graphical Model to comprise one or more Extension variables (VarVarX1, VarX2 . . . , VarXN), each said Extension variable corresponding to the outputs of said machine learning model, and
performing an embedding training of said extended Probabilistic Graphical Model on the basis of an embedding training set of data, said embedding training set comprising first training data (D1.1) of data from said specified context (C1) and an inferred machine learning model output (O1.2) inferred by said machine learning model from third training data (D1.2) from context C1 corresponding to said second set of Observable variables (VarA, VarB . . . , VarZ), whereby third training data (D1.2) is sampled from said context (C1) together with said first training data (D1.1), to obtain an enhanced Probabilistic Graphical Model comprising parameters defining dependencies between said Observable variables, said class variable and each said Extension variable.

2. The method of claim 1, wherein one or more Observable variables (Var1, Var2, Var3, . . . , VarN) of a said Probabilistic Graphical Model are directly dependent on the said class variable, and one or more Latent variables.

3. The method of claim 1, wherein said Probabilistic Graphical Model is extended with one or more Extension variables (VarVarX1, VarX2 . . . , VarXN), whereby said Extension variables are directly dependent on the said class variable, one or more Latent variables and possibly one or more said Observable variables.

4. The method of claim 1, wherein said step of obtaining a Probabilistic Graphical Model comprises training said Probabilistic Graphical Model with said first training data (D1.1) from said specified context (C1), said first training data comprising data corresponding to a first set of one or more Observable variables (Var1, Var2, Var3, . . . , VarN), whereby embedding training using said embedding training set modifies only the parameters corresponding to the dependencies between the said Extension variables and other variables in said extended Probabilistic Graphical Model.

5. The method of claim 1, wherein embedding training using said embedding training set modifies all parameters corresponding to the dependencies between all variables in said extended Probabilistic Graphical Model.

6. The method of claim 1, wherein there are provided one or more further machine learning models each said further machine learning model comprising said second set of Observable variables (VarA, VarB, . . . , VarZ), and each said further machine learning model output O1.2 comprising probabilities corresponding to the values of said Extension variables (VarVarX1, VarX2, . . . , VarXN) of said extended Probabilistic Graphical Model, and wherein
said step of performing an embedding training of said extended Probabilistic Graphical Model is performed, such that conditional probability tables of said Extension variables (VarVarX1, VarX2 . . . , VarXN) are obtained.

7. The method of claim 1, wherein there are provided one or more further machine learning models each said further machine learning model comprising said second set of Observable variables (VarA, VarB, . . . , VarZ), and each said further machine learning model output O1.2 comprising values that are not probabilities, said values corresponding to the states of Observed Extension Variables, a subset of said Extension variables (VarVarX1, VarX2 . . . , VarXN), whereas the rest of said Extension variables are Latent Extension Variables , wherein said Observed Extension Variables are conditioned on said Latent Extension Variables, and said step of performing an embedding training of a Probabilistic Graphical Model is performed such that for each said Observed Extension Variable and each said Latent Extension Variable a specific probability table is obtained.

8. The method of claim 1, whereby said Extension variables are directly dependent on the said class variable.

9. The method of claim 1, wherein said second training data (D2) belongs to said specified context (C1).

10. The method of claim 1, wherein said step of training said machine learning model comprises incorporating said machine learning model as the Latent representation of an autoencoder.

11. The method of claim 1, wherein said machine learning model is trained in an unsupervised mode.

12. The method of claim 1, wherein said context comprises the conditions corresponding to the geographic locations, time and the type of moving entities in a physical space under which the data is sampled.

13. The method of claim 1, wherein said first training data, second training data and third training data comprise kinematic data for moving entities in a physical space.

14. The method of claim 13, wherein said first training data, second training data and third training data further comprise images, video streams, sound or electromagnetic signatures.

15. A method of classifying data comprising presenting said data to a classifier in accordance with claim 1.

16. The method of claim 1 applied to classification of targets in combat management systems, or in processing of sensor observations or detections of moving targets, wherein the first set of Observable variables (Var1, Var2, Var3, . . . , VarN) and the second set of Observable variables (VarA, VarB, VarC, . . . , VarZ) correspond to (i) the outputs of various sensors perceiving the targets and (ii) outputs of sources describing the environmental conditions and wherein the dependencies between said Observable variables, said class variable and each said Extension variable describe the correlations between the context, the observations and the target class, enabling classification of a target, prediction of its states or detection of anomalous target states.

17. The method of claim 1 applied to detection of anomalies in IT systems, cyber physical systems and detection of cyber attacks, wherein the first set of Observable variables (Var1, Var2, Var3, . . . , VarN) and the second set of Observable variables (VarA, VarB, VarC, . . . , VarZ) correspond to the readings from various IDS probes at different system levels and wherein the dependencies between said Observable variables, said class variable and each said Extension variable describe the correlations between different components of the overall system, such that the states of unobservable components can be predicted or anomalous states of components can be detected.

18. A data processing system comprising means for carrying out the method of claim 1.

19. A computer program comprising instructions which, when the program is executed by a computer, cause the computer to carry out the method of claim 1.

20. A computer-readable medium comprising instructions which, when executed by a computer, cause the computer to carry out the method of claim 1.
